(19) United States
(12) Patent Application Publication
(10) Pub. No.: US 2010/0110210 A1
(43) Pub. Date: May 6, 2010

(54) METHOD AND MEANS OF RECORDING FORMAT INDEPENDENT CROPPING INFORMATION

(76) Inventor: Wayne E. Prentice, Honeoye Falls, NY (US)

Correspondence Address: Peter P. Hernandez;Patent Legal Staff, Eastman Kodak Company, 343 State Street, Rochester, NY, 14650-2201, US

(21) Appl. No.: 12/265,769

(22) Filed: Nov. 6, 2008

(51) Int. Cl. H04N 5/228

(52) U.S. Cl. 348/222.1; 348/E05.031

(57) ABSTRACT

A digital camera includes a display for viewing a scene; a processor for directing one or more indicators to be displayed on the display each indicator representative of an aspect ratio; and memory for storing a captured image and for storing metadata of the indicator selected by a user that is associated with the captured image.

### FIELD OF THE INVENTION

The present invention generally relates to image processing and more particularly to image processing that permits a user to view on the camera display in real time the actual cropping effects that will occur when the images are printed in hardcopy form or viewed in a display with an aspect ratio that differs from that of the image source.

### BACKGROUND OF THE INVENTION

When a digital image is created regardless of the source: scanner, digital camera, or computer generated, it has an aspect ratio. When the image is displayed or viewed it can be on the context of various aspect ratios. Common prints sizes: 4×6, 5×7, 8×10 or 11×17 for example, all have different aspect ratios. Computer monitors and home televisions typically have either: 4:3 or 9:16 aspect ratios. When an image is displayed on a device with an aspect ratio that differs from the source, the image can be either “letterboxed” or “pillar boxed” by scaling the longest dimension of the image to match the longest dimension of the display. In this case, the shorter dimension will not fill the screen, thus requiring some area of the display to be filled with non-image data. Another strategy is to fill the display by scaling the shorter dimension to fill the display, thus making the longer dimension too large to fit on the screen. In this case, some decision must be made as to what area of the image should be removed or cropped to fit the display. Currently fixed rules are applied; for example, it can retain the center portion of the image and remove the edge image data. This method fails to consider the scene content potentially resulting in an area of interest being removed while a less important part of the scene is retained. Another method is to use automatic subject detection at the time of display to determine the most important region to retain. These approaches, at best, attempt to guess the intentions of the creator of the digital image.

Consequently, a need exists for an apparatus and method which more accurately identifies the user's intention of aspect ratio.

### SUMMARY OF THE INVENTION

The present invention is directed to overcoming one or more of the problems set forth above. Briefly summarized, according to one aspect of the present invention the present invention resides in a digital camera having a display for viewing a scene; a processor for directing one or more indicators to be displayed on the display each indicator representative of an aspect ratio; and memory for storing a captured image and for storing metadata of the one or more indicators that is associated with the captured image.

Another solution which is the focus of this invention is to record at image creation time, or some other point prior to re-display, data that either specifies cropping boundaries for various aspect ratios or regions of the image that are not-expendable.

This object is achieved by recording cropping information that may be known prior to actually removing pixel information. For example, at capture time, cropping gradicules may be present on the camera live preview to indicate a print boundary, automated subject detection may provide information for cropping, or the user may indicate regions of the image that must be saved or may be cropped. Such information can be stored as either print size dependent where the actual crop boundaries are recorded or independent where a region of the image is defined as crop-out at last resort.

These and other objects, features, and advantages of the present invention will become apparent to those skilled in the art upon a reading of the following detailed description when taken in conjunction with the drawings wherein there is shown and described an illustrative embodiment of the invention.

### ADVANTAGEOUS EFFECT OF THE INVENTION

The present invention has the advantage of preventing the removal of important image information at any image exchange where a display aspect ratio change can occur downstream.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

While the specification concludes with claims particularly pointing out and distinctly claiming the subject matter of the present invention, it is believed that the invention will be better understood from the following description when taken in conjunction with the accompanying drawings, wherein:

FIG. 1 is a block diagram of a camera of the present invention;

FIG. 2 is a back view of the camera of the present invention illustrating the display;

FIG. 3 is the camera of the present invention having an alternative embodiment for the display;

FIG. 4 is a table illustrative of data in electronic memory that is used in conjunction with FIG. 3;

FIG. 5A is a back view of an alternative embodiment of the camera of the present invention; and

FIG. 5B is FIG. 5A after re-composing the scene for eventual capture.

### DETAILED DESCRIPTION OF THE INVENTION

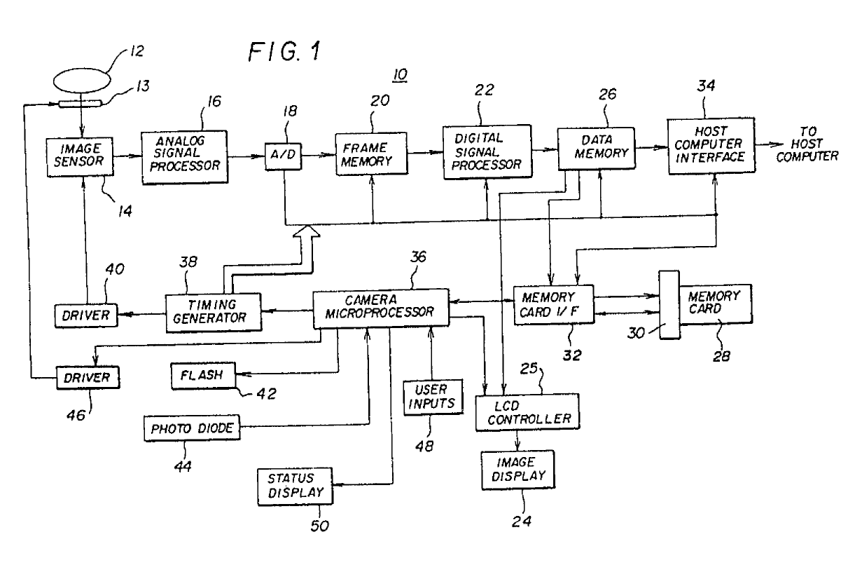

Referring to FIG. 1, a block diagram of an exemplary digital camera 10 in accordance with a first embodiment of the present invention is shown. As shown in FIG. 1, the digital camera 10 includes a lens 12 which directs image light from a subject (not shown) through an aperture/shutter controller 13 upon an image sensor 14 having a discrete number of photosensitive sites or pixels arranged in a two-dimensional array to form individual photosensitive sites corresponding to the pixels of the image. The image sensor 14 can be a charge coupled device (CCD) sensor or a complementary metal oxide semiconductor (CMOS) imager. The photosensitive sites of the image sensor 14 collect charge in response to incident. Each photosensitive site is overlaid with a color filter array (CFA), such as the Bayer CFA described in commonly-assigned U.S. Pat. No. 3,971,065, the disclosure of which is herein incorporated by reference. The Bayer CFA has 50% green pixels in a checkerboard mosaic, with the remaining pixels alternating between red and blue rows. The photosensitive sites respond to the appropriately colored incident light illumination to provide an analog signal corresponding to the intensity of illumination incident on the photosensitive sites.

The analog output of each pixel is amplified and analog processed by an analog signal processor (ASP) 16 to reduce the image sensor's output amplifier noise. The output of the ASP 16 is converted to a digital image signal by an analog-to-digital (A/D) converter 18, such as, for example, an 8 bit A/D converter which provides an 8 bit signal in the sequence of the Bayer CFA.

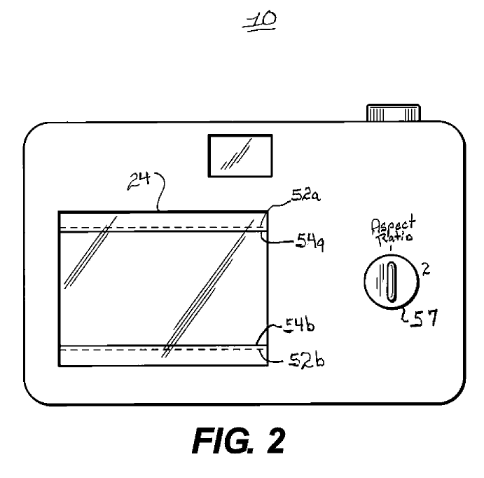

The digitized image signal is temporarily stored in a frame memory 20, and is then processed and compressed by a digital signal processor (DSP) 22. The image processing typically includes white balance, color correction, tone correction, and image sharpening. The DSP 22 also decimates (or re-samples) the digitized image signal for each still image to produce a thumbnail image having fewer pixels (i.e., lower resolution) than the original captured image as described in commonly-assigned U.S. Pat. No. 5,164,831 to Kuchta et al., the disclosure of which is herein incorporated by reference. The image file containing both the full resolution image and the thumbnail image is stored in a data memory 26, and then transferred through a memory card interface 32 to a memory card 28 that is present in a memory card slot 30 of the digital camera 10. The thumbnail image is also sent to an image display 24 through an LCD controller 25 where the user can view the image. Although the display is shown as an LCD display, OLED displays may also be used. The image display 24, which is shown in more detail in FIG. 2 and which will be discussed later, includes a conventional arrangement for displaying the captured image. The image display 24 may, alternatively, utilize many other types of raster image displays, including miniature CRT's, organic light emitting diode (OLED) arrays, or field emission displays.

The memory card 28 can be adapted to the PCMCIA card interface standard, such as described in the PC Card Standard, Release 2.0, published by the Personal Computer Memory Card International Association, Sunnyvale, Calif., September 1991. The memory card 28 can also be adapted to the Compact Flash interface standard, such as described in the CompactFlash Specification Version 1.3, published by the CompactFlash Association, Palo Alto, Calif., Aug. 5, 1998.

Electrical connection between the memory card 28 and the digital camera 10 is maintained through a card connector (not shown) positioned in the memory card slot 30. The memory card interface 32 and the card connector provide, e.g., an interface according to the aforementioned PCMCIA card or CompactFlash interface standard. The image file may also be sent to a host computer (not shown), which is connected to the digital camera 10 through a host computer interface 34.

In operation, a camera microprocessor 36 receives user inputs 48, such as from a shutter release (not shown), and initiates a capture sequence by signaling a timing generator 38. The timing generator 38 is connected generally to the elements of the digital camera 10, as shown in FIG. 1, for controlling the digital conversion, compression, and storage of the image signal. The camera microprocessor 36 also processes a signal from a photodiode 44 for determining a proper exposure, and accordingly signals an exposure driver 46 for setting the aperture and shutter speed via the aperture/shutter controller 13 and triggers a flash unit 42 (if needed). The image sensor 14 is then driven from the timing generator 38 via a sensor driver 40 to produce the image signal. The user inputs 48 are used to control the operation of the digital camera 10 in a well-known manner.

Referring to FIG. 2, there is shown a back view of the camera 10 of the present invention having an exploded view of the display 24. The display 24, preferable 4:3 aspect ratio, may be made of well known display materials such as LCD, OLED and the like. The processor 36 (see FIG. 1) is programmed to instruct the display 24 to display straight cropping lines or substantially straight cropping lines 52a, 52b, 54a and 54b (hereinafter referred to as gradicules) on the display 24. These gradicules are mated (52a with 52b; and 54a with 54b) in pairs at opposite ends of the display 24 so that the area between the mated gradicules (52a, 52b, 54a and 54b) represents a particular hardcopy print size. It is noted for clarity that that area between the mated gradicules 52a, 52b, 54a and 54b is the same aspect ratio (not necessarily the exact same size) of the particular print size. For example, gradicules 54a and 54b represent the image that would be printed on a 4×6 inch hardcopy print. Each pair of mated gradicules represents a different hardcopy print size—5×7 inches (52a and 52b); 8×10 inches and the like. Although only two mated pairs of gradicules are shown, three or more may be shown depending on the desired number of aspect ratios. This conveniently alerts and informs the user as to that actual hardcopy image that would be printed with this particular capture thus assisting them with image composition at capture time.

Summarizing this embodiment in its intended application, the plurality of gradicules 52a, 52b, 54a and 54b are displayed on the back of a digital camera live view display 24. At capture time, these gradicules 52a, 52b, 54a and 54b can be used to indicate the aspect ratio of various print sizes or other downstream viewing conditions. The user would then frame the subject in a way that would be appropriate for the desired aspect ratios. The user selects the desired aspect ratio by manually turning the user interface 57. This information would then be recorded in metadata in the form of a table that describes the boundaries for each destination print size. At print or display time on another device, the metadata and image information could then be used to decide what image information could be cropped from the image.

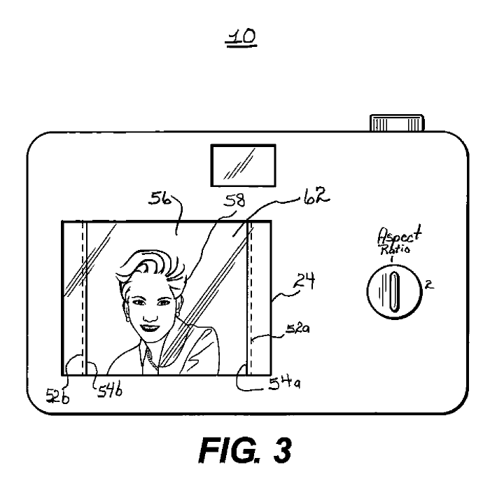

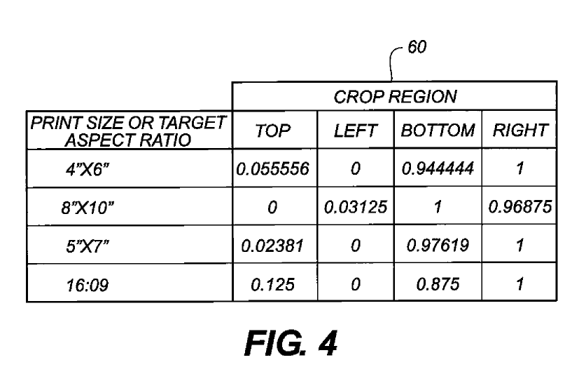

Referring to FIGS. 3 and 4, there is shown a display of an alternative embodiment of the present invention (FIG. 3) and a table (FIG. 4) that is stored in memory 26 and/or 28 and that works in cooperation with the display 24. The display 24 includes a display area 56 in which one or more subjects 58 (a woman in this case) are contained from a scene to be captured. The user selects an aspect ratio as described above. The processor 36 executes “subject detection” routines that detect the one or more subjects 58. Subject detection software routines are well known in the art and will not be discussed in detail herein. For example, U.S. Pat. No. 6,940,545 discloses examples of subject detection routines which may be used with the present invention. Once the subject 58 is detected, the processor 36 retrieves the table 60 and analyzes what area or areas of the to-be-captured image (or captured if already captured) will be cropped for each hardcopy print size according to the table 60. This crop region is adjusted so that the detected subjects 58 are not altered and only or substantially only background areas 62 of the image are cropped. This information would then be stored and recorded in memory 26 and/or 28 as metadata that describes the boundaries for each destination print size. It is noted that the table in FIG. 4 using normalized coordinates where the top left corner normalized to (0,0) and the bottom right corner is (1,1). The crop values are two points: Top Left (x,y) and Bottom Right (x,y).

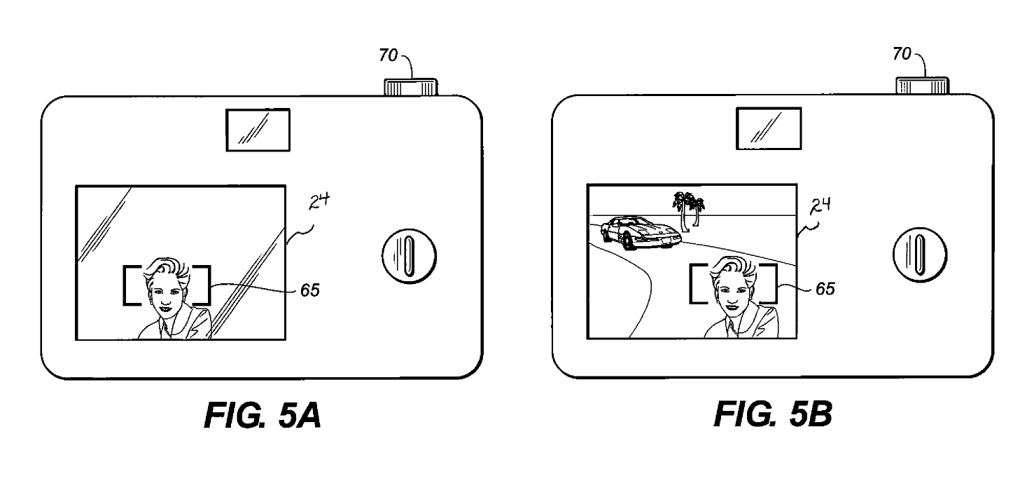

Referring to FIG. 5A, in another embodiment, the user could identify the subject area, identified by the electronic brackets 65 displayed on the display 24, at the time of image composition. Experienced users of digital cameras will center the subject (enclose the primary subject with the brackets 65) and press the shutter button 70 half-way to lock in exposure and focus. A disclosure for locking in exposure and control is found in U.S. Pat. No. 5,103,254 and will not be discussed in detail herein. Referring to FIG. 5B, then the user will recompose the image by adjusting the capture range of the camera to include any other scene to be captured (such as the automobile and tree) and complete the capture. In this case, the camera would track the subject within the brackets 65 (which tracking is represented by the brackets moving with the subject) during image re-composition and record its location. This data would then be stored in memory and used by a downstream cropping process as an indicator that image data in the recorded, bracketed region should not be removed from the display image.

The invention has been described in detail with particular reference to certain preferred embodiments thereof, but it will be understood that variations and modifications can be effected within the spirit and scope of the invention. For example, a variation would involve the user using a device or software that interactively allows the subject of the image to be identified, or in some cases where the subject may not be a specific element of the scene, what regions of the image are less importation to the overall aesthetic of the image.

### PARTS LIST

10 Camera
12 Lens
13 aperture/shutter controller
14 Image Sensor
16 Analog Signal Processor
18 A/D converter
20 Frame Memory
22 Digital Signal Processor
24 image display
25 LCD controller
26 Data Memory
28 memory card
30 memory card slot
32 memory card interface
34 Host Computer Interface
36 Camera Microprocessor
38 Timing Generator
40 Driver
42 Flash
44 Photodiode
46 Driver
48 User Inputs
50 Status Display
52a-52b Lines
54a-54b Lines
56 Display Area
57 User Interface
58 Subject
60 table
62 Background
65 electronic brackets
70 Shutter Button

1. A digital camera comprising:
(a) a display for viewing a scene;
(b) a processor for directing one or more indicators to be displayed on the display each indicator representative of an aspect ratio; and
(c) memory for storing a captured image and for storing metadata of the indicator selected by a user that is associated with the captured image.

2. The digital camera as in claim 1 further comprising cropping lines visual on the display as the indicator.

3. The digital camera as in claim 2, wherein the memory stores a plurality of images and stores the metadata of the indicator that is associated with each captured image.

4. The digital camera as in claim 3, wherein the display has a 4:3 aspect ratio.

5. A digital camera comprising:
(a) a display for viewing a scene;
(b) one or more indicators on the display each for indicating an aspect ratio one of which is selectable by a user;
(c) a processor for detecting a subject on the display; and
(d) one or more memory modules for storing the captured image and metadata of the selected aspect ratio and for storing a table containing a plurality of aspect ratios and a corresponding crop area for each aspect ratio.

6. The digital camera as in claim 5 further comprising cropping lines visual on the display as the indicator.

7. The digital camera as in claim 6, wherein the memory stores a plurality of images and stores the metadata of the indicator that is associated with each captured image.

8. The digital camera as in claim 7, wherein the display is a 3 inch by 4 inch display.

9. A digital camera comprising:
(a) a display for viewing a scene;
(b) an electronic bracket on the display for permitting a user to select a subject;
(c) a processor for permitting tracking of the selected subject during re-composition; and
(d) a shutter control for capturing the recomposed scene and the selected subject in a single image.
